(19) United States
(12) Patent Application Publication
(10) Pub. No.: US 2002/0157905 A1
(43) Pub. Date: Oct. 31, 2002

(54) Self adjusting braking apparatus

(76) Inventors: Randall R. Bendtsen, Peoria, IL (US); Jens M. Erp, Dekalb, IL (US); Alan D. Gustafson, Aplington, IA (US); Cary J. Lyons, Morton, IL (US)

Correspondence Address: CATERPILLAR INC., 100 N.E. ADAMS STREET, PATENT DEPT., PEORIA, IL, 616296490

(21) Appl. No.: 09/843,636

(22) Filed: Apr. 26, 2001

(51) Int. Cl. F16D 55/02

(52) U.S. Cl. 188/71.8

(57) ABSTRACT

A brake apparatus includes a brake disk secured to a shaft and a reaction plate secured to a housing. The brake apparatus further includes a fluid actuated piston which urges the brake disk against the reaction plate to slow rotation of the shaft and an adjustment member positioned by the piston. The brake apparatus yet further includes a spring interposed between the adjustment member and the piston. The piston positions the adjustment member relative to the brake disk when fluid is applied to said piston. The spring urges the piston away from the adjustment member and brake disk when fluid pressure is removed from the piston.

### TECHNICAL FIELD

The present invention generally relates to a braking apparatus, and more specifically to a self adjusting braking apparatus.

### BACKGROUND

Hydraulically actuated brakes operate by applying a volume of pressurized fluid against a piston. The piston urges a disk attached to a shaft against a reaction member attached to a fixed structure. Friction between the disk and the reaction member causes the rotation of the shaft to slow or stop. Repeated application of the brakes causes wear on the surface of the disk which increases the distance which the piston must travel in order to slow the shaft. This increased distances requires a greater volume of pressurized fluid to be applied to the piston to create the same frictional force.

A disadvantage to requiring a greater volume of pressurized fluid to actuate the brake is that a larger master cylinder is required to supply the pressurized fluid. This larger cylinder can increase the cost of the braking system. A further disadvantage of a larger volume master cylinder is that the larger volume of fluid will causes more energy to be lost to viscous forces between the fluid and the disk when braking is not being performed. Brakes can be manually adjusted to move a contact surface of the piston closer to the disk, thus reducing the volume of pressurized fluid required and reducing the size of the required master cylinder. However, manual adjustment of the piston is costly, labor intensive, and time consuming. In addition, estimating the rate of wear of the friction material is difficult, making the timing of the brake adjustment difficult to predict.

What is needed therefore is a self adjusting braking apparatus which overcomes the above-mentioned drawbacks.

### SUMMARY OF THE INVENTION

In accordance with a first aspect of the present invention, there is provided a brake apparatus including a brake disk secured to a shaft and a reaction plate secured to a housing. The brake apparatus further includes a fluid actuated piston which urges the brake disk against the reaction plate to slow rotation of the shaft and an adjustment member positioned by the piston. The brake apparatus yet further includes a spring interposed between the adjustment member and the piston. The piston positions the adjustment member relative to the brake disk when fluid is applied to said piston. The spring urges the piston away from the adjustment member and brake disk when fluid pressure is removed from the piston.

In accordance with a second aspect of the present invention, there is provided a method of operating a brake apparatus having a brake disk secured to a shaft, a reaction plate secured to a housing, a fluid actuated piston which urges the brake disk against the reaction plate to slow rotation of the shaft, an adjustment member positioned by the piston, and a spring interposed between the adjustment member and the piston. The method includes the steps of positioning the adjustment member relative to the brake disk by applying fluid to the piston, and urging the piston away from the adjustment member and brake disk with the spring when fluid pressure is removed from the piston.

### BRIEF DESCRIPTION OF THE DRAWINGS

FIG. 1 is a cross-sectional view of a brake assembly in a non-actuated position which incorporates the features of the present invention therein;

FIG. 2 is a view similar to FIG. 1 but showing the brake assembly in an actuated position; and

FIG. 3 is a cross-sectional view of an alternative brake assembly.

### DETAILED DESCRIPTION

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

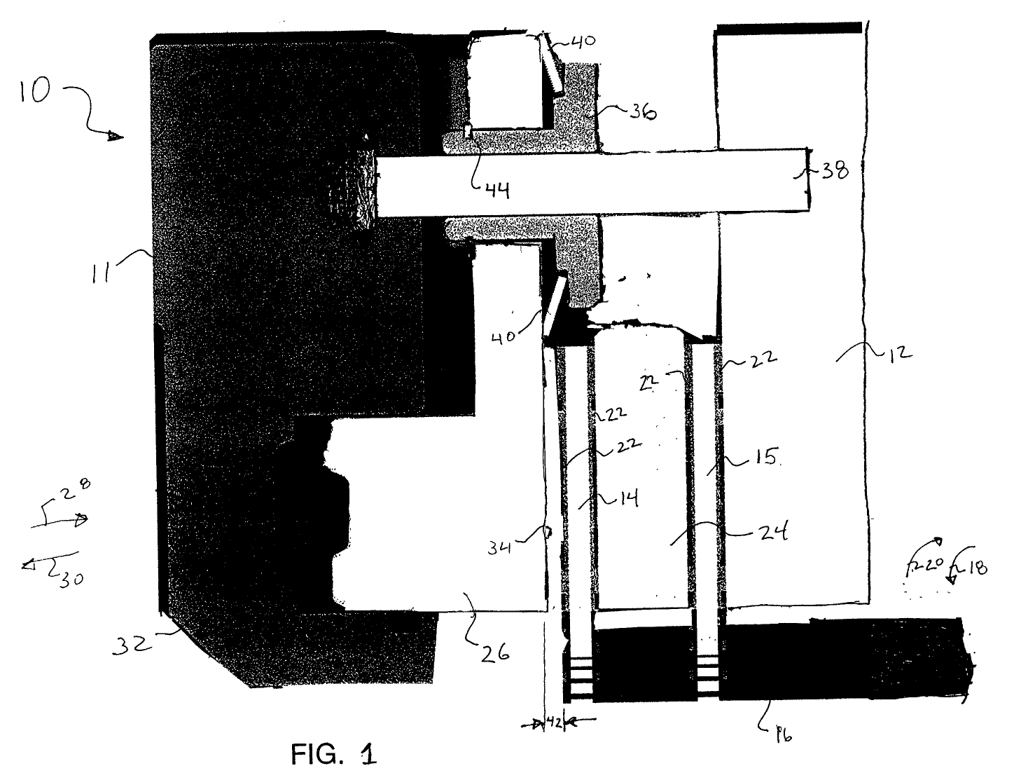

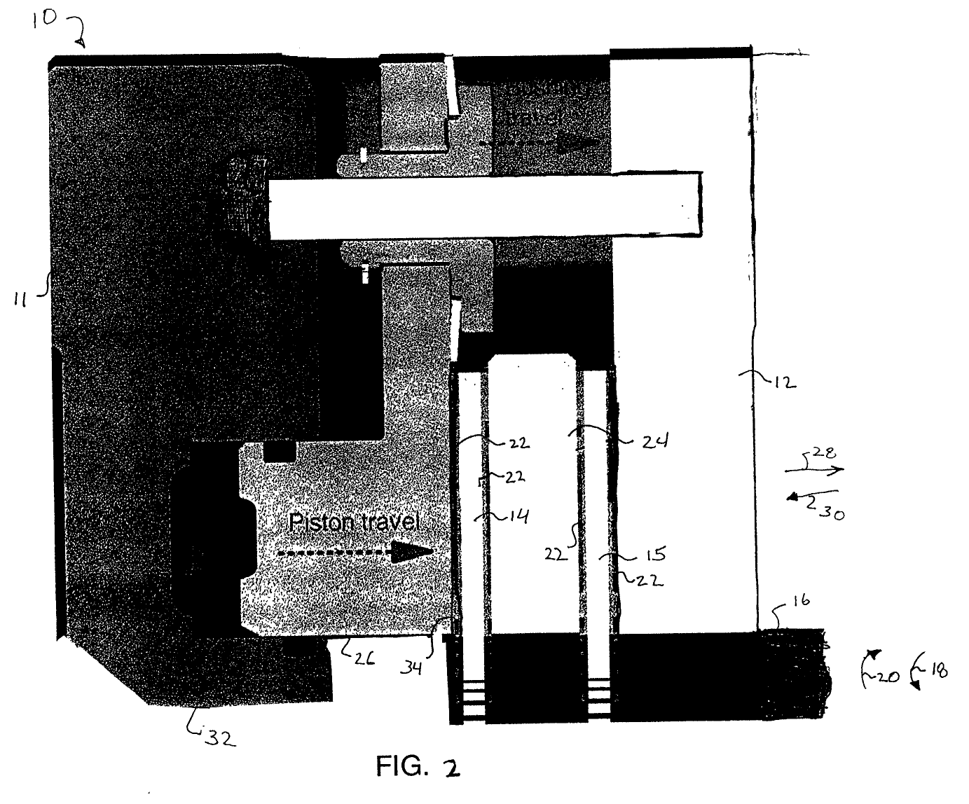

Referring now to FIGS. 1 and 2, there is shown a cross-sectional view of a braking apparatus 10 which incorporates the features of the present invention therein. The braking apparatus 10 includes a housing 11 and a reaction member 12 secured to the housing 11. The braking apparatus 10 also includes a pair of brake disks 14,15 secured to a rotating shaft 16. The shaft 16 is operable to rotate in the general direction of arrows 18 and 20 relative to the housing 11. Each surface of the brake disks 14,15 is coated with a frictional material 22. The braking apparatus 10 further includes a separator plate 24 positioned between an adjacent pair of brake disks 14,15.

The braking apparatus 10 further includes a piston 26 operable to translate relative to the housing 11 in the general direction of arrows 28 and 30. The piston 26 is in fluid communication with a fluid cavity 32 defined within the housing 11. To slow or stop rotation of the shaft 16, a volume of pressurized fluid is supplied to the cavity 32 by a pressure source, such as a master brake cylinder (not shown). As pressurized fluid is supplied to the cavity 32, the hydraulic force of the pressurized fluid on the piston 26 urges a contact surface 34 of the piston 26 against the brake disk 14. As the piston 26 moves further in the general direction of arrow 28, the brake disk 14, the separator plate 24, and the brake disk 15 are compressed against the reaction member 12 (as shown in FIG. 2). The frictional forces of the piston 26, separator plate 24, and reaction member 12 acting on the frictional material 22 of the disks 14,15 causes the shaft 16 to slow or stop rotating in the general direction of arrow 18 or 20.

It should be appreciated that repeated use of the braking apparatus 10 will cause material to wear from the contact surface 34 of the piston 26, frictional material 22 on the disks 14,15, the surfaces of the separator plate 24, and the surface of the reaction member 12. It should further be appreciated that this wear will require the piston 26 to travel farther in the general direction of arrow 28 to slow the rotation of the shaft 16 as material wears in the braking apparatus 10, unless the piston is continually repositioned. Moreover, this increase in travel distance of the piston 26 requires that a larger volume of fluid be supplied to the cavity 32 to slow the shaft 26.

The braking apparatus 10 farther includes a bushing or adjustment member 36, shown in FIG. 2, which is in sliding contact with a pin 38 secured to the housing 11, such that the adjustment member 36 is free to slide or translate along the pin 38 in the general direction of arrows 28 and 30 parallel to the movement of the piston 26. The braking apparatus 10 further includes a spring 40 or biasing member interposed between the adjustment member 36 and the contact surface 34 of the piston 26. The biasing member 40 may either be a bellville spring (shown in FIGS. 1 and 2), a coil spring (not shown), or other spring.

Referring to FIG. 2, to actuate the brake assembly 10, pressurized fluid is supplied to the cavity 32 and the piston 26 moves in the general direction of arrow 28 compressing the spring 40 between the contact surface 34 and the adjustment member 36 such that the contact surface 34 positions the adjustment member 36 relative to the pin 38 and brake disk 14. As the components within the brake assembly 10 wear, the adjustment member 36 moves farther in the general direction of arrow 28 to account for the increased movement of the piston 26 required to slow the shaft 16.

Referring now to FIG. 1, to deactuate the brake assembly 10, pressurized fluid is removed from the cavity 32 allowing the spring 40 to urge the piston 26 back in the general direction of arrow 30 to maintain a clearance 42 between the contact surface 34 of the piston 26 and the brake disk 14. The braking apparatus 10 further includes a retaining ring 44 secured to the adjustment member 36 which limits the movement of the piston 26 relative to the adjustment member 36 in the general direction of arrow 30. It should be appreciated that the frictional force between the pin 38 and the adjustment member 36 is greater than the force of the spring 40 on the adjustment member 36 such that the spring force does not reposition the adjustment member 36 relative to the pin 38 and disk 14. In addition, the force of the spring 40 on the piston 26 must be greater than the frictional forces between the piston 26 and the housing 11 in order for the spring 40 to move the piston 26 in the general direction of arrow 30.

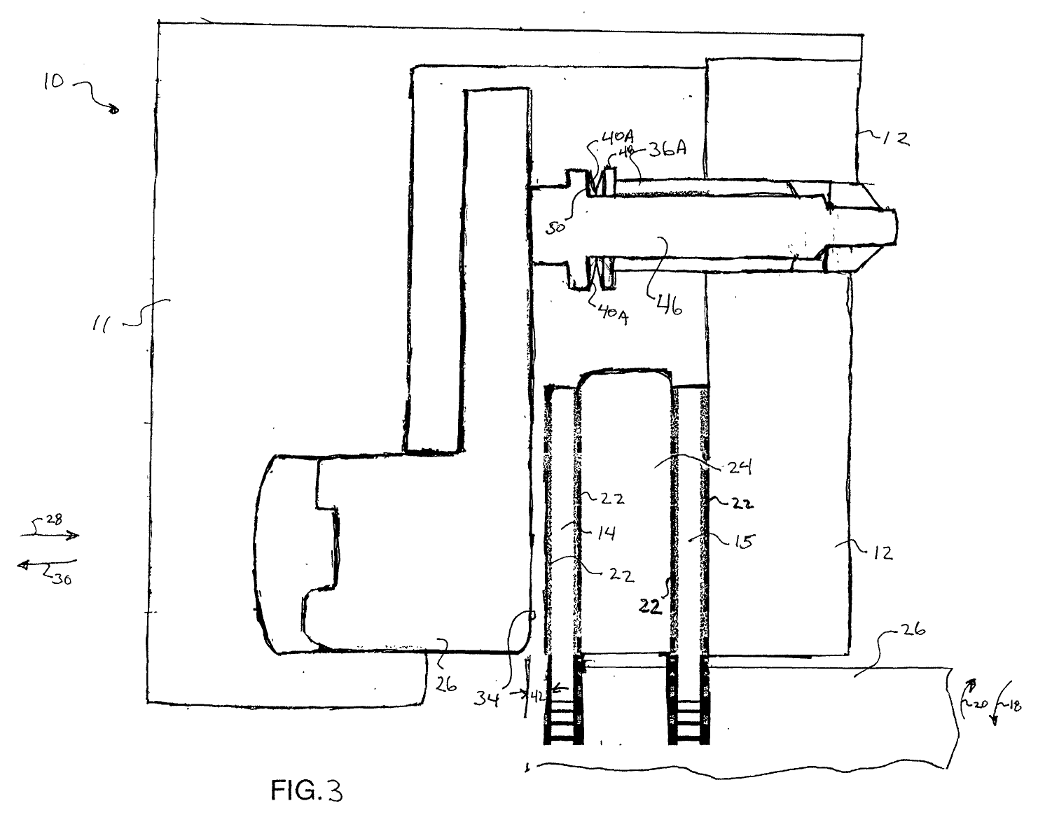

Referring now to FIG. 3, there is shown an alternative embodiment of the present invention. Many of the components of the alternate embodiment are the same a the first disclosed embodiment and will not be described in detail for the sake of brevity. The Adjustment member 36A is a sleeve in sliding contact with the reaction member 12. The braking apparatus 10 further includes a bolt 46 positioned within the adjustment member 36A and placed in contact with the contact surface 34 of the piston 36. A ring 48 is placed about the bolt 46 and in contact with the adjustment member 36A. A spring 40A is interposed between a head 50 of the bolt 46 and the ring 48. The spring 40A may either be a bellville spring (shown in FIG. 3), or a coil spring (not shown), or similar device.

To actuate the brake assembly 10, pressurized fluid is supplied to the cavity 32 which moves the piston 26 in the general direction of arrow 28. As the piston 26 moves, the contact surface 34 urges the bolt 46 to compress the spring 40A between the head 50 of the bolt 46 and adjustment member 36A such that the contact surface 34 positions the adjustment member 36A relative to the reaction member 12 and brake disk 14. As the components within the brake assembly 10 wear, the adjustment member 36A will move farther in the general direction of arrow 28 to account for the increased movement of the piston 26 required to slow the shaft 16.

To deactuate the brake assembly 10, pressurized fluid is removed from the cavity 32 and the spring 40A urges the piston 26 back in the general direction of arrow 30 to maintain the clearance 42 between the contact surface 34 of the piston 26 and the brake disk 14. It should be appreciated that the frictional force between the reaction member 12 and the adjustment member 36A is greater than the force of the spring 40A on the adjustment member 36A such that the spring force does not reposition the adjustment member 36A relative to the reaction member 12 and disk 14. In addition, the force of the spring 40A on the piston 26 must be greater than the frictional forces between the piston 26 and the housing 11 in order for the spring 40A to move the piston 26 in the general direction of arrow 30.

### Industrial Applicability

In operation, the braking apparatus 10 slows the shaft 16 by supplying pressurized fluid to the cavity 32. The pressurized fluid urges the piston 26 against the brake disk 14 and the contact surface 34 of the piston 26 repositions the adjustment member 36, 36A relative to the disk 14. As various components in the braking apparatus 10 wear, the adjustment member 36,36A is moved farther in the general direction of arrow 28 to account for this wear.

When the pressurized fluid is removed from the cavity 32, the spring 40,40A urges the piston away from the adjustment member 36,36A so as to maintain a gap 42 between the contact surface 34 of the piston 26 and the brake disk 14. Thus, regardless of the amount of wear on the components of the braking apparatus 10, only a small amount of pressurized fluid must be supplied to the cavity 32 to urge the piston 26 against the brake disk 14 and slow the rotation of the shaft 16.

While the invention has been illustrated and described in detail in the drawings and foregoing description, such illustration and description is to be considered as exemplary and not restrictive in character, it being understood that only the preferred embodiment has been shown and described and that all changes and modifications that come within the spirit of the invention are desired to be protected.

What is claimed is:

1. A brake apparatus, comprising,
a brake disk secured to a shaft;
a reaction plate secured to a housing;
a fluid actuated piston having a contact surface which urges the brake disk against the reaction plate to slow rotation of the shaft;
an adjustment member positioned by the contact surface; and
a spring interposed between the adjustment member and the contact surface, wherein:
the contact surface positions the adjustment member relative to the brake disk when fluid is applied to the piston, and
the spring urges the contact surface away from the adjustment member and brake disk when fluid pressure is removed from the piston.

2. The apparatus of claim 1, further comprising a pin secured to the housing and positioned parallel to movement of the piston, wherein:
the adjustment member is a bushing positioned in sliding contact with the pin,
movement of the piston toward the brake disk repositions the bushing relative to the pin, and
the frictional force between the pin and the bushing is greater than the force of the spring on the bushing such that the spring force does not reposition the bushing relative to the pin.

3. The apparatus of claim 2, wherein the spring is a bellville spring interposed between the bushing and the contact surface.

4. The apparatus of claim 2, wherein the spring is a coil spring interposed between the bushing and the contact surface.

5. The apparatus of claim 2, further comprising a retaining ring secured to the adjustment member, wherein the retaining ring limits the movement of the piston relative to the adjustment member.

6. The apparatus of claim 2, wherein the force of the spring on the piston is greater than the frictional forces between the piston and the housing.

7. The apparatus of claim 1, wherein:
the adjustment member includes a sleeve in sliding contact with the housing and a bolt positioned in the sleeve,
movement of the piston toward the brake disk urges a head of the bolt into the sleeve which repositions the sleeve relative to the housing, and
the frictional force between the sleeve and the housing is greater than the force of the spring on the sleeve such that the spring force does not reposition the sleeve relative to the housing.

8. The apparatus of 7, wherein the spring is a bellville spring interposed between the sleeve and the head of the bolt.

9. The apparatus of claim 7, wherein the force of the spring transmitted to the piston is greater than the frictional forces between the piston and the housing.

10. A method of operating a brake apparatus having (i) a brake disk secured to a shaft, (ii) a reaction plate secured to a housing, (iii) a fluid actuated piston having a contact surface which urges the brake disk against the reaction plate to slow rotation of the shaft, (iv) an adjustment member positioned by the contact surface, and (v) a spring interposed between the adjustment member and the contact surface, comprising the steps of:
positioning the adjustment member relative to the brake disk by applying fluid to the piston; and
urging the piston away from the adjustment member and brake disk with the spring when fluid pressure is removed from the piston.

11. The method of claim 10, wherein the brake apparatus further comprises a pin secured to the housing and positioned parallel to movement of the piston and the adjustment member is a bushing positioned in sliding contact with the pin, further comprising the steps of:
moving the piston toward the brake disk;
repositioning the bushing relative to the pin in response to the moving step; and
preventing movement of the bushing with the frictional force between the pin and the bushing.

12. The method of claim 11, wherein the urging step includes the step of interposing a bellville spring between the bushing and the contact surface.

13. The method of claim 11, wherein the urging step includes the step of interposing a coil spring between the bushing and the piston.

14. The method of claim 11, the brake apparatus further comprising a retaining ring secured to the adjustment member, further comprising the steps of limiting movement of the piston relative to the adjustment member with the retaining ring.

15. The method of claim 10, wherein the adjustment member includes a sleeve in sliding contact with the housing and a bolt positioned with the sleeve, further comprising the steps of:
moving the piston toward the brake disk to urge a head of the bolt into the sleeve to reposition the sleeve relative to the housing; and
preventing movement of the sleeve by the spring with the frictional force between the sleeve and the housing.

16. The method of claim 16, the urging step further comprising the step of interposing a bellville spring between the sleeve and the head of the bolt.

17. The method of claim 15, further comprising the step of limiting the frictional forces between the piston and the housing to less than the force of the spring transmitted to the piston.
